(19) United States
(12) Patent Application Publication
(10) Pub. No.: US 2009/0167502 A1
(43) Pub. Date: Jul. 2, 2009

(54) Device for verifying a location and functionality of a radio-frequency identification (RFID) tag on an item

(75) Inventors: David P. Erickson, Stillwater, MN (US); James P. McGee, Cedar, MN (US); Michele A. Waldner, Minneapolis, MN (US); Ronald D. Jesme, Plymouth, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/006,284

(22) Filed: Dec. 31, 2007

(51) Int. Cl. G08B 13/14; G06K 7/00; H04Q 5/22

(52) U.S. Cl. 340/10.3; 340/10.1; 340/572.1; 340/10.51

(57) ABSTRACT

A Radio-Frequency Identification (RFID) system verifies proper placement and functionality of RFID tags with respect to particular end-use RFID systems at the time the RFID tag is applied to an item but before the item is deployed. A device for verifying a location and functionality of an RFID tag on an item includes an item holder, a power coupling mechanism attached to the item holder, and an RFID reader electrically connected to the power coupling mechanism. The power coupling mechanism creates a near field for transmission of read or write commands from the RFID reader to an RFID tag on an item placed on the item holder to verify the location and functionality of the RFID tag as applied to the item with respect to a near-field coupling mechanism of a particular end-use RFID system. The device may include additional power coupling mechanisms for testing the functionality of the tag.

### TECHNICAL FIELD

In general, the invention relates to radio-frequency identification (RFID) systems, and, more particularly, to verifying functionality of radio-frequency identification (RFID) tags for use within the RFID systems.

### BACKGROUND

Radio-Frequency Identification (RFID) technology has become widely used in virtually every industry, including transportation, manufacturing, waste management, postal tracking, airline baggage reconciliation, and highway toll management. A typical RFID system includes a plurality of RFID tags, at least one RFID reader or detection system having an antenna for communication with the RFID tags, and a computing device to control the RFID reader. The RFID reader includes a transmitter that may provide energy or information to the tags, and a receiver to receive identity and other information from the tags. The computing device processes the information obtained by the RFID reader.

A variety of RFID applications, systems and tags are known. For example, U.S. Patent Application Publication entitled, “Radio Frequency Identification in Document Management,” (Eisenberg et al.), Publication No. 2002/0196126 A1, discloses various systems and methods of handling items with RFID tags, such as files. As another example, PCT Publication WO 00/10122 A2, “Radio Frequency Identification Systems Applications,” (Garber, et al.) describes the use of RFID systems for use with items of interest having RFID tags, such as in a library. As yet another example, U.S. Pat. No. 6,768,419, “Applications for Radio Frequency Identification Systems” (Garber, et al.) describes RFID devices, including handheld RFID devices, and applications for such devices. Another example, U.S. Patent Publication No. 2003/0189490 A1, “Radio-Frequency Identification Tag and Tape Applicator, Radio-Frequency Identification Tag Applicator, and Methods of Applying Radio-Frequency Identification Tags” describes methods of applying a radio-frequency identification tag to tape and radio-frequency identification tag and tape applicators.

One example of RFID tags is described in U.S. Pat. No. 7,132,946, entitled “Variable Frequency Radio Frequency Identification (RFID) Tags,” (Waldner and Erickson), which describes various radio frequency identification (RFID) tags that dynamically vary their resonant frequency to reduce or eliminate the potential effects of electromagnetic “tag-to-tag” coupling. Another example of RFID tags is described in U.S. Pat. No. 7,268,687, “Radiofrequency Identification Tags with Compensating Circuitry.”

### SUMMARY

In general, the invention relates to a Radio-Frequency Identification (RFID) system for verifying proper placement and functionality of RFID tags with respect to particular applications at the time the RFID tag is applied to an item but before the item is deployed in a system. More specifically, the invention relates to ensuring that an RFID tag meets application-specific performance criteria. A device is described for both verifying that an RFID tag is properly located on an item and verifying that the RFID tag as applied to the item meets the application-specific performance criteria.

A variety of RFID systems may be used to automate the inventory of items having RFID tags attached to the items. Handheld RFID readers, RFID portals, or smart storage areas are a few examples of particular applications of RFID system technology. One problem that may arise in many RFID applications is the ability to reliably detect the RFID tag in a specific application. Both the placement of the RFID tag on an item and the environment in which the RFID tag is attempted to be interrogated for a particular application may affect the readability of the RFID tag. In addition, individual RFID tag performance may vary due to a variety of issues in the process of manufacturing the RFID tags. Moreover, individual RFID tag performance may change as RFID tags age.

While some manufacturers may provide a quality check of rolls of RFID tags, this is typically a simple read pass/fail check of each tag performed at high speed during production of the roll using an electromagnetic field created by an RFID reader at a fixed power setting. Such a performance check during production of the RFID tag does not take into account the type of item to which the RFID tag will be attached or how the RFID tag will be read or written in the end-use application. For example, identifying function of RFID tags before application of the RFID tags to an item does not take into account any effects on RFID tag functionality of the position of the RFID tag on the item, the material of the item, or the manner in which the RFID tag will be subsequently read or written.

The techniques described herein allow the RFID tag to be tested for proper positioning and functionality of the RFID tag as applied to an item after the an RFID tag has been applied to the item but before the RFID-tagged item is introduced into the end-use RFID system environment. In addition, the techniques provide the ability to ensure that the RFID tag meets certain application-specific criteria after the RFID tag is applied to the item and prior to deployment to the end-use RFID system environment. The techniques may be applied to any of a variety of RFID systems, such as handheld RFID readers, RFID portals, smart storage areas, or other RFID systems.

In one embodiment, a device for verifying a location and functionality of an RFID tag on an item includes an item holder and a signal line affixed to the item holder. The device further includes an RFID reader electrically connected to the signal line. The signal line creates a near field for transmission of read or write command signals from the RFID reader to an RFID tag on an item placed on the item holder. The RFID reader verifies the location and functionality of the RFID tag with respect to a near-field coupling mechanism of a particular end-use RFID system.

In another embodiment, a method of verifying a location and functionality of an RFID tag on an item comprises providing a device for verifying a location and functionality of an RFID tag on an item. The device includes an item holder, a signal line attached to the item holder, and an RFID reader electrically connected to the signal line. The signal line creates a near field for transmission of read or write command signals from the RFID reader to an RFID tag on an item placed on the item holder, and wherein the RFID reader verifies the location and functionality of the RFID tag as applied to the item with respect to a near-field coupling mechanism of a particular end-use RFID system. The method further includes calibrating the device such that the device produces a near field that simulates a near field expected to be produced by the near-field coupling mechanism of the end-use RFID system, attaching an RFID tag to an item, inserting the item into the item holder of the device, transmitting RF signals from the RFID reader to the RFID tag with the RF antenna at a power level for simulating the particular end-use RFID system, and verifying the functionality of the RFID tag with respect to the end-use RFID system upon determining that the RF signals were successfully received by the RFID tag.

In yet another embodiment, a system for verifying a location and functionality of an RFID tag on an item comprises an item having an RFID tag attached to the item. The system further includes a device comprising an item holder, a signal line attached to the item holder, and an RFID reader electrically connected to the signal line, wherein the signal line creates a near field for power coupling with the RFID tag on the item when the item is placed on the item holder, and wherein the RFID reader verifies the location and functionality of the RFID tag with respect to a near-field coupling mechanism of a targeted end-use RFID system. The system further includes a computer in operative connection to the RFID reader, wherein the device interacts with software running on the computer to characterize the performance of RFID tag with respect to the near-field coupling mechanism of the end-use RFID system and provide a user with feedback on the performance characteristics of the RFID tag.

In a further embodiment, a device for verifying a location and functionality of a radio-frequency identification (RFID) tag on an item comprises an item holder, an RFID reader, and at least two power coupling mechanisms connected to the RFID reader for power coupling with an RFID tag affixed to an item placed within the item holder. The at least two power coupling mechanisms include at least: (i) a first power coupling mechanism that produces an electric field for near-field power coupling with the RFID tag, and (ii) a second power coupling mechanism that produces an electromagnetic field for far-field coupling with the RFID tag.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a front perspective view of a file tracking system.

FIG. 2 is a side view of a row of files stored on a shelf in the file tracking system of FIG. 1.

FIG. 3A is a side view of a file having an RFID tag.

FIG. 3B is a side view of a file having a ultra-high frequency (UHF) tag.

FIG. 4 is a side view of one embodiment of a device for verifying a location of a radio-frequency identification tag on an item, and an item inserted into the device, such as the file of FIG. 3A.

FIG. 5 is a perspective view of the device of FIG. 4.

FIG. 6 is a perspective drawing illustrating an example RFID system for verifying the placement and functionality of an RFID tag affixed to an item.

FIG. 7 is a flowchart illustrating example operation of the RFID system of FIG. 6.

FIG. 8 is a block diagram illustrating an example end-use RFID application in which a storage area includes a shelf containing a signal line for interrogating RFID tags affixed to files.

FIG. 9A is a schematic diagram illustrating a perspective view of an exemplary embodiment of a shelf containing a signal line.

FIG. 9B is a schematic diagram illustrating a perspective view of an exemplary signal line structure.

FIG. 10 is a graph illustrating magnitudes of example electromagnetic fields produced by an example antenna at various cross-sectional positions relative to a strip line of an RFID shelf microstrip antenna, measured with the RFID tag at various distances from the RFID shelf antenna.

FIG. 11 is a perspective drawing illustrating another example RFID system for verifying the placement and functionality of an RFID tag affixed to an item.

### DETAILED DESCRIPTION

A variety of items or objects are now being tagged with radio frequency identification (RFID) tags for use in RFID systems that will assist in identifying the item and tracking the item through various processes. For a variety of applications and processes, it may be necessary to have the RFID tag located in a particular area on the item and not located in other areas on the item, and located where it is desirable to have an RFID tag attached to the item in a predictable location, depending on the application or process. If the RFID tag is not located in its proper location on the object, the RFID system may fail to read the RFID tag and as a result, the information stored on the RFID tag will not be recorded by the RFID system and it will affect the performance of the RFID system and systems or persons relying upon information read by the RFID system. Therefore, there is a need to provide a device and methods that assist a user in verifying whether or not an RFID tag is properly located on an item or object.

One example where RFID tag placement on items or objects could be important are on products that are being further processed by a customer. For example, pallets being delivered to Wal*mart stores are now required to each have RFID tags that identify the products on the pallet. The Wal*mart stores may have specific methods of reading the RFID tags with particular RFID readers and particular methods of unloading the products from the pallet. To meet Wal*mart's requirements for further processing, the provider of the products may need to attach the RFID tag in a particular location on the pallet to make it easier for Wal*mart to further process the pallet and the items thereon at their locations.

As another example, many parts are being provided with RFID tags where the parts are later assembled into a final product or assembly by a customer. When the parts are supplied to the customer, the placement of the RFID tag could be important when it comes time for the customer to assemble their final product. The customer may require that the part include the RFID tag in a particular location, so that when the final product is assembled the RFID tag can be easily read. Otherwise, if the RFID tag is in the wrong location, the RFID tag may not be readable when the final part is assembled.

As yet another example, an item or object may require multiple RFID tags in different locations each having a different frequency. For example, a pallet may require one RFID tag having a frequency of 13.56 MHz and another RFID tag having a frequency of 915 MHz. The 915 MHz tag has a longer read range and may be read in the warehouse, when the pallet is being stored. The 13.56 MHz tag has a shorter read range and may be read along a conveyor belt as it is being transported to the manufacturing line. As another example, a UHF tag may be used to be read along the conveyor belt. For example, such tags may be placed on items that are grouped together but yet sufficiently spaced so that only the nearest tag is read.

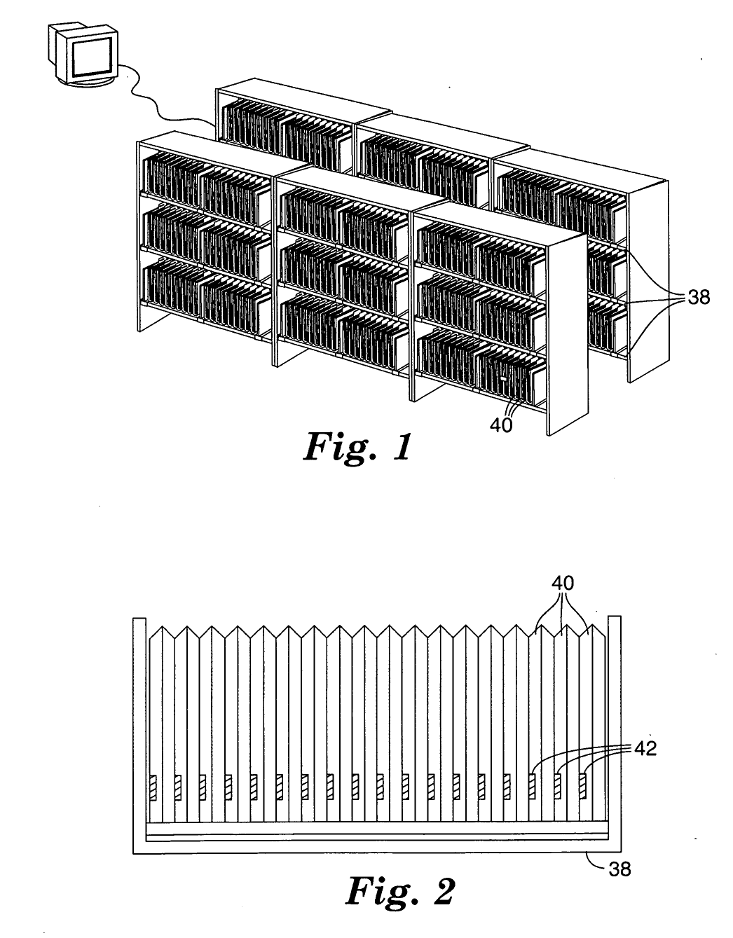

Another example of items having an RFID tag attached to them is files. Despite some interest in converting offices to paperless environments in which paper documents are entirely replaced by electronic versions of those documents, a number of industries continue to rely heavily on paper documents. Examples include law offices, government agencies, and facilities for storing business, criminal, and medical records. In some instances these records are stored in enclosed filing cabinets. In other instances, the files 40 are positioned on open shelves 38 of the type shown in FIG. 1. Documents and files can also be found in other locations, including on desks and tables, in drawers, on carts, or stacked on the floor.

At least three patent publications describe the use of radio frequency identification (RFID) systems for document or file management: 1) U.S. Pat. No. 5,689,238 (Cannon, Jr. et al.); 2) PCT Published Patent Application No. WO 00/16280; and 3) U.S. Patent Application Publication entitled, “Radio Frequency Identification in Document Management,” (Eisenberg et al.), Publication No. 2002/0196126 A1, which is assigned to the assignee of the present invention and the contents of which are incorporated by reference herein. Although the various aspects of the present invention will largely be described in the context of files or documents or both, the device of the present invention may be used in verifying the location of RFID tags on other items including books, video tapes, optically-recorded media, or retail items, pallets, containers, or other assets, as appropriate, whether or not each of these items is specifically called out as an alternative application.

RFID tags or labels 42 are made by various manufacturers including Texas Instruments of Dallas Tex., under the designation “Tag-it”. Another type of RFID tag is actually a combination tag that includes an RFID element and a magnetic security element, and is described in U.S. Pat. No. 6,154,137, which is assigned to the assignee of the present invention, the contents of which is incorporated by reference herein. Yet another type of RFID tag is described in U.S. Pat. No. 7,132,946, entitled “Variable Frequency Radio Frequency Identification (RFID) Tags,” (Waldner and Erickson), which is assigned to the assignee of the present invention, the entire contents of which is incorporated by reference herein. An RFID tag typically includes an integrated circuit with a certain amount of memory, a portion of which may be used by the manufacturer to write certain information to the tag (and perhaps lock it to protect it from being changed or overwritten), and another portion of which may be used by a purchaser to store additional information to the tag. The integrated circuit is operatively connected to a radio frequency (RF) antenna that receives RF energy from a source and also backscatters RF energy in a manner well known in the art. It is this backscattered RF energy that provides a signal that may be received by an interrogator or reader to obtain information about the RFID tag, and the item with which it is associated. RFID tags may operate in one or more different frequency ranges.

RFID tags may be associated with or applied to items of interest, as described above. The tag may even be embedded within the item or the packaging of the item so that the tag is at least substantially imperceptible, which can help to prevent detection and tampering. Thus, it would be possible to “source-mark” items with an RFID tag, such as inserting an RFID tag into or applying an RFID tag to an item during its manufacture, as with a book, compact disc, consumer product, file folder, pallet, carton, box-sealing tape, shipping label, or the like.

In conventional RFID systems, RFID tags may interfere with one another when the RFID tags are placed in close proximity to one another. It has been determined that electromagnetic coupling between such tags may result in a shift of the resonant frequencies of the tags. This shifted resonant frequency may not provide a given one of the RFID tags with a sufficient induced current to power the tag, thereby causing the RFID tag to be out of the detectable frequency range of the interrogation device.

In general, the magnitude of the resulting frequency shift is dependent upon the distance between the RFID tags, the size of the tags, the amount of coplanar overlapping that occurs between the tags, and the total number of tags that overlap. Some exemplary measurements of frequency shift due to “tag-to-tag” coupling are shown in Table 1 below when multiple tags where placed within a fixed proximity of each other in an overlapping position. In Table 1, A is the height of the tag, B is the width of the tag, N is the number of overlapping tags, X is the distance between consecutive tags, and F is the resultant resonant frequency of the tag. Although the exemplary measurements shown in Table 1 are downward frequency shifts, the frequency shifts caused by tag coupling may also be upward frequency shifts. As can be seen from Table 1, electromagnetic coupling between ten overlapping tags at the given separation distance can shift the frequency at which the tags respond approximately 2 MHz, which may result in the inability for the reader to successfully communicate with the tags, or in a significantly reduced read range.

TABLE 1

| A | B | | X | F |
|---|---|---|---|---|
| (Inches) | (Inches) | N | (Inches) | (MHz) |
| 2 | 3 | 1 | — | 13.56 |
| 2 | 3 | 2 | .75 | 13.2 |
| 2 | 3 | 10 | .75 | 10.5 |
| .5 | 1.5 | 1 | — | 13.56 |
| .5 | 1.5 | 2 | .375 | 13.4 |
| .5 | 1.5 | 10 | .375 | 10.6 |

One method of overcoming the tag-to-tag interaction is to reduce the degree to which adjacent tags overlap each other. This can be done by increasing the distance between adjacent tags. Alternatively, tag-to-tag interaction may be reduced by systematically staggering the locations of RFID tags associated with file folders, documents, containers, or other items so that it is very unlikely that the tags on two adjacent items would overlap each other to any substantial degree. Use of the device described herein to verify the proper placement in a systematically staggered tag system would also help ensure proper functioning of such a system.

However, it may not always be possible to increase the distance between adjacent tags on items, such as requiring fixed file storage spacers, because it may require additional filing space that may be expensive to maintain. It also may not always be possible to stagger the locations of the RFID tags because although this method may initially reduce the tag-to-tag interaction when the files are first stored on the shelf, due to the insertion and removal of files over time, the files may become unordered and ultimately lead to the overlapping of tags and thus, tag-to-tag interaction.

The inventors of the present invention have discovered that the magnitude of the resulting frequency will tend to stabilize after a certain number of tags on various items have been successively overlapped. As a result, if a series of similar items each having an RFID tag attached to them in relatively the same general area are stacked either vertically or horizontally relative to each other (for example, RFID tagged files stored on a shelf illustrated in FIG. 2), such that the RFID tags on the items overlap causing tag-to-tag interaction, then it is possible to predict and control the magnitude of the resulting resonant frequency. For example, if ten items each having an RFID tag of approximately the same general area and the antennas of the RFID tags are tuned to approximately 20 MHz, then an RFID reader operating at 13.56 MHz will be able to successfully read the majority of the RFID tags when the items are adjacent one another. However, to achieve the desired resonant frequency that is a result of the tag-to-tag interaction in an application such as closely spaced files, it is desirable to attach the RFID tags to the items in the same general area. For example, the files 40 illustrated on the shelf 38 in FIG. 2 each have an RFID tag 42 that is attached in approximately the same area of the file 40, such that when the files are aligned and stored on the shelf 38, the RFID tags on adjacent files are placed in close proximity to one another to achieve the desired tag-to-tag interaction.

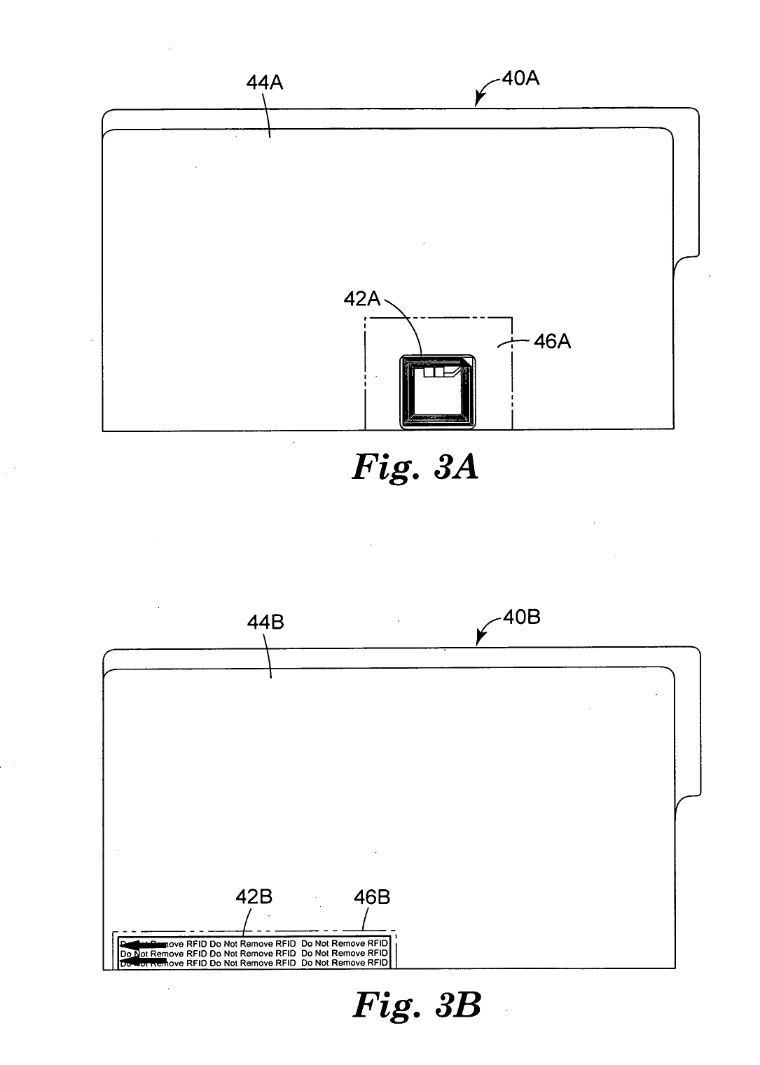

FIG. 3A illustrates one embodiment of a file 40A having an RFID tag 42A attached to it, by adhesive for example, or embedded into the file 40A. There is an area 46A on the file where the RFID tag 42A is properly located to help achieve the tag-to-tag interaction described above, when the files are stored along a shelf, as illustrated in FIG. 2. If the RFID tag 42A is attached anywhere outside of that area 46A on the file 40A, then it is not properly located on the file 40A to achieve the desired tag-to-tag interaction, and in turn, the desired performance of the RFID system. The area 46A is determined based on the antenna design and its read range or antenna volume described in more detail below.

FIG. 3B illustrates another embodiment of a file 40B having an UHF tag 42B attached to it. Area 46B of FIG. 3B is an area where the UHF tag 42B is properly located to achieve the desired performance of the RFID system.

A device is described for verifying the location of an RFID tag on an item, which is useful for achieving the desired tag-to-tag interaction when the files are placed in close proximity to one another, as described above. However, the techniques of the invention are more broadly useful for preparing items where it is desirable to have an RFID tag attached to the item in a predictable location, depending on the application of the item in an RFID system. See U.S. Pat. No. 7,295,120 to Waldner et al., entitled “Device for verifying a location of a radio-frequency identification (RFID) tag on an item,” the entire contents of which are incorporated by reference herein. For example, for RFID tagged items used in an RFID system that includes placing such items on a conveyor where the conveyor has a stationary RFID reader, each item must be read by the RFID reader as it passes by the reader. For this application, it may be desirable to have the RFID tag in an area easily readable by the reader, as the item progresses past the reader along the conveyor belt, and therefore the RFID tag should be in relatively the same area on each item to enhance the performance of the system.

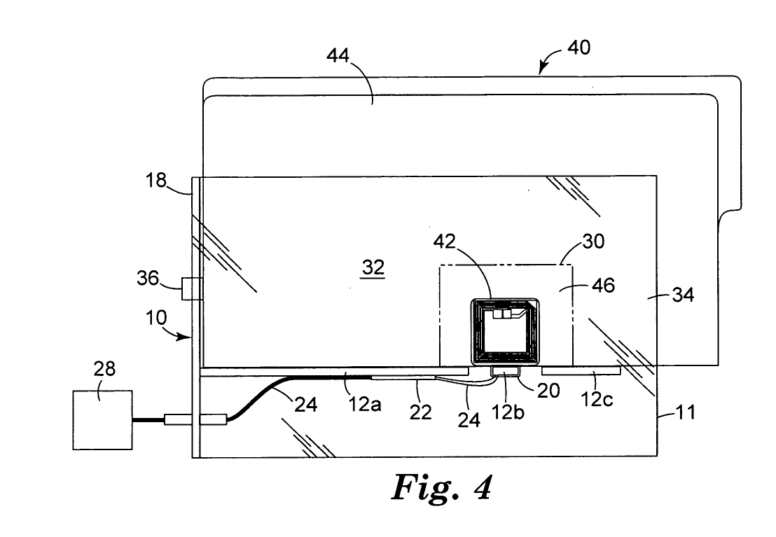

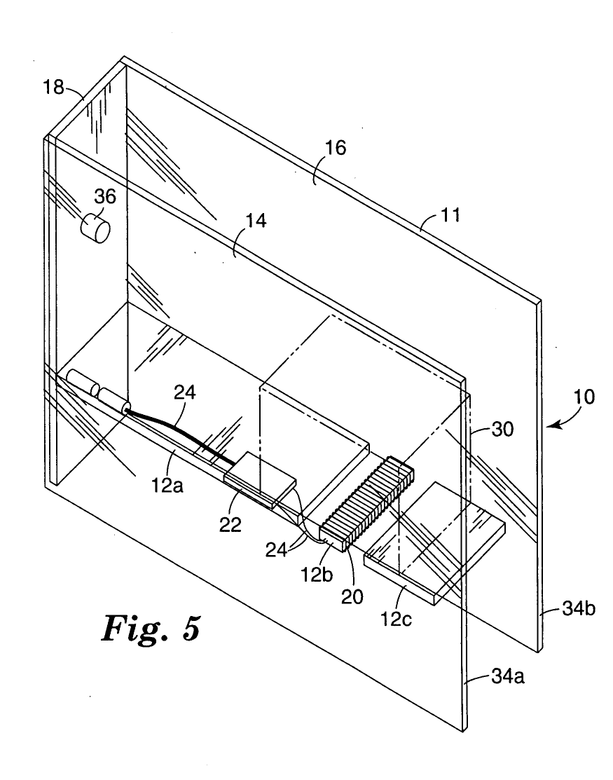

FIG. 4 illustrates one embodiment of the device 10 with an item 40 having an RFID tag 42 placed in the device 10. FIG. 5 illustrates the device 10 by itself.

In the embodiment illustrated in FIGS. 4 and 5, the device 10 includes an item holder having a first support 12, a second support 14, a third support 16, and a fourth support 18. The second support 14 and third support 16 are parallel to one another and preferably provides vertical support for the item 40. The fourth support 18 is perpendicular to the second support 14 and the third support 16, and also preferably provides vertical support for the item 40. The second support 14, third support 16, and fourth support 18 are rectangular in shape and the third support 18 adjoins the first support 14 to the second support 16 forming walls for an item 40 to be placed between. The first support 12 is made from three separate portions 12a, 12b, and 12c, and preferably provides horizontal support for the item. The first support 12 is mounted in the lower half of the device between the second support wall 14 and third support wall 16, and is preferably perpendicular to both the second and third support walls 14, 16 and the fourth support 18.

Preferably, the supports 12, 14, 16, 18 are made from clear plastic or other nonmetallic materials, however other suitable materials may be used. The supports 12, 14, 16, 18 may be adjoined in any way known in the art, for example, by adhesive. Alternatively, the supports 12, 14, 16, 18 may be formed into a unitary support. Although the embodiment of the device 10 illustrated in FIGS. 4 and 5 is sized and shaped to hold a file, the device may be sized and shaped to hold or support any item having an RFID tag. The item holder can be any arrangement of an antenna relative to an item having an RFID tag such that the antenna is designed to ensure and verify proper placement of the RFID tag on the item for the specific system or application. For instance, the device 10 may include an item holder that is a support with a flat surface, where the item is placed on top of the flat surface.

The device 10 includes an RF antenna 20 for reading and writing command signals to an RFID tag 42. The antenna 20 preferably is a helical antenna or a loop antenna, however any RF antenna known in the art is suitable dependent upon system requirements. In the embodiment illustrated in FIGS. 4 and 5, the antenna is attached to a portion of the first support 12b. The device 10 includes an RFID reader or interrogation source 28. The RFID reader 28 is in operative connection to the RF antenna 20. The RFID reader signals to the user if the RFID tag is not properly read or written by the RF antenna. The device 10 preferably includes a circuit board 22, with its associated components, and wires 24 for connecting the RF antenna 20 to the RFID reader 28. One suitable example of a commercially available RFID reader is available from Royal Philips Electronics located in Eindhoven, Netherlands as part number SLRM900.

The folder 40 has an RFID tag 42 attached to it at a certain predetermined location. The holder 11 is designed to receive the folder 40 with the RFID tag 42. When the folder 40 is inserted into the holder 11, it is supported horizontally by the first support 12 and supported vertically by the second support 14 and third support 16, and fourth support 18.

The device 10 verifies the location of the RFID tag 42 on the item, such as a folder 40, by successfully reading information from or writing information to the RFID tag. If there is a successful read of information from or write of information to the RFID tag, it is assumed then that the RFID tag 42 is properly located on the item 40. However, if there is not a successful reading or writing of information, then it is assumed that the RFID tag 42 is in the wrong location on the item 40 and it will have to be removed and replaced with an RFID tag 42 in the proper location. Alternatively, if there is not a successful reading or writing of information, then it may be assumed that the RFID tag 42 is not properly functioning. The antenna 20 on the device 10 is designed so that it will only read or write information successfully on the RFID tag 42, if the RFID tag 42 is located within certain areas in or relative to the item holder 11. As a result of the antenna design, the device has a certain area or volume in which the RF antenna can successfully read or write to an RFID tag 42, which is indicated as the readable volume 30. This volume is determined by the antenna type, size, power, and the use of an optional metal layer or other suitable materials in the device, discussed in more detail below. One skilled in the art may use these various factors to design a suitable RF antenna for the specific application.

The device 10 may include optional metal layer 34 to help shield the areas of the item 40 that preferably do not include an RFID tag 42 or areas that are not to be readable or writeable for the applicable system. For instance, metal layers 34 may be included in the second support 14 and third support 16. The metal layers are sized and shaped to surround portions of the outer perimeter of the readable volume 30, to help control the read range or volume of the antenna 20. The metal layer helps reduce the readable volume of the antenna 20 and allow for more control over the acceptable location of the RFID tag 42 on the item 40. Preferably, the metal layer is copper. However, other suitable materials may be used.

The device 10 may include an optional sensor 36. When the sensor 36 is activated, such as by inserting the file 40 into the holder 11, as illustrated in FIG. 4, the antenna reads information from or writes information to the RFID tag 42 on the file 40. Examples of suitable sensors are commercially available from Osrum Opto Semiconductors located in Regensburg, Germany, as part number SFH9240. Other sensors known in the art are suitable, for example, optical sensors, such as photo resistors, transmissive optical sensors, reflective optical sensor or a simple pressure switch.

The device 10 may be designed to include a variety of antennas located in different locations within the holder 11, depending on the desired application. For example, an item may include multiple locations where an RFID tag may be properly located. U.S. Patent Application Publication, “Radio Frequency Identification in Document Management,” (Eisenberg et al.), Publication No. 2002/0196126 A1, discloses the need for staggering the location of RFID tags on files. A device 10 could use one antenna to read one RFID tag on a one location on a file and then use a different antenna to read another RFID tag on a different location on another file. The antenna also may be designed to read RFID tags on files even if the file is inserted into the holder in a flipped over position, such that the RFID tag is located on the opposite side of the file. One skilled in the art may design the antenna to include a read range or antenna volume designed for the specific item and for use in a specific application or RFID system.

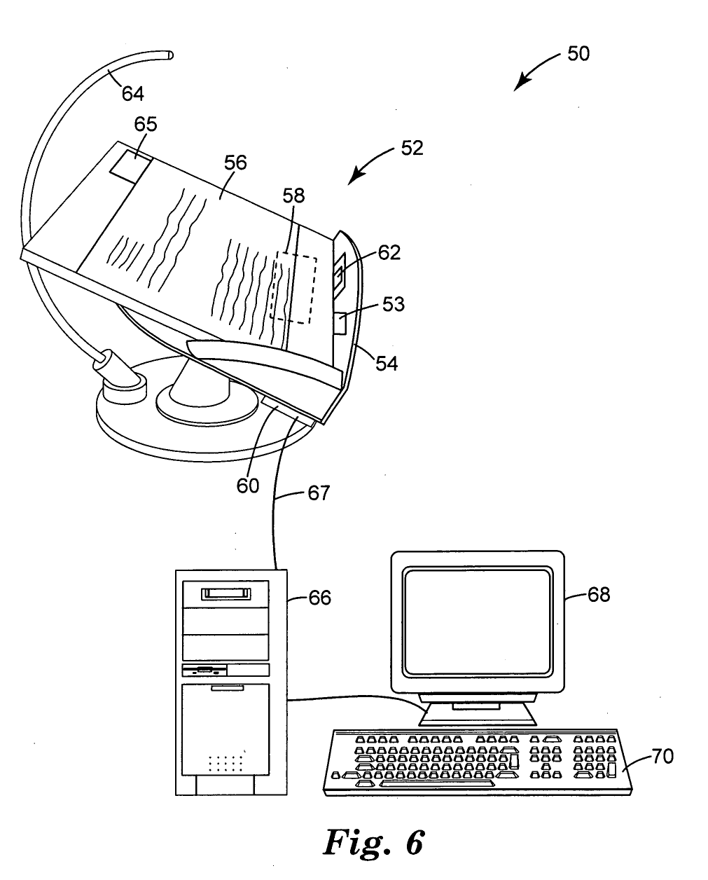

FIG. 6 is a perspective drawing illustrating an example RFID system 50. RFID system 50 includes a second exemplary device 52 for verifying the location and functionality of RFID tags on items with respect to an end-use RFID environment within which the items will ultimately be utilized. In the example of FIG. 6, device 52 includes an item holder 54 that may hold an item, such as file 56. File 56 may have an RFID tag 58 (shown by dotted lines) attached to the underside of file 56 or to an inner surface of file 56. In other embodiments, RFID tag 58 may be attached to a top surface of file 56. RFID reader 60 interrogates the RFID tag 58 to test the functionality of the tag using a signal line 62 coupled to RFID reader 60.

As described herein, device 52 and signal line 62 may be configured to simulate a particular end-use application in which RFID tags will ultimately be employed. RFID reader 60 may also be calibrated or otherwise operated so as to simulate conditions of the particular application. For example, device 52 may be designed such that a distance and orientation of RFID tag 58 with respect to signal line 62 emulates acceptable worst-case conditions that are anticipated in the end-use RFID application once file 56 is deployed within the end-use application, e.g., stored on a shelf.

In addition, an output power of reader 60 may be calibrated or otherwise controlled by computer 66 to produce an electromagnetic field having a field strength at the location of the RFID tag that is substantially equal to a minimum field strength that has been determined to be reliably produced from an RFID antenna in the end-use interrogation system. As a result, the functionality of RFID tag 58 with respect to the particular application, as well as the positioning of RFID tag 58 on-file 56, may be tested as a basis for predicting how RFID tag 58 would perform in an environment that is the same or similar to the end-use RFID environment that will be encountered once file 56 is put to use. In this way, RFID tags 58 on files 56 may be tested for acceptable functionality relative to the performance requirements specified for a particular RFID application, i.e., of a particular type of RFID system and surrounding conditions.

For example, device 52 may be configured to take into consideration conditions stemming from a particular end-use environment, such as electromagnetic interactions from packaging of a product, electrical interference from co-located equipment or machinery, or other environmental conditions that may likely exist at a particular end-use application. In this way, device 52 is designed to test the functionality of RFID tag 58 as applied to a particular item or product to be used within a particular application, as opposed to merely testing functionality of RFID tag 58 alone. Device 52 may be used to ensure that RFID tag 58 as applied to file 56 meets minimum read/write performance standards for a particular application after RFID tag 58 is positioned on file 56. Example performance standards include ensuring that RFID tag 58 is sufficiently energized by the electromagnetic field of signal line 62 to reach a minimum voltage required to successfully read data from RFID tag 58 using RFID reader 60 and a minimum voltage required to successfully write data to RFID tag 58 using RFID reader 60.

RFID system 50 may be used to test RFID tag 58 for functionality with respect to a variety of different end-use applications having different conditions that may influence RFID communication with the RFID tags. RFID system 50 may be configured in different ways depending on the particular end-use application being tested. For example, different types of signal line 62 may be used for different end-use applications, and device 52 may be configured in a modular form such that signal line 62 may be electrically and physically disconnected, removed and replaced with a signal line or an RFID antenna of a different structure. As another example, RFID reader 60 may be calibrated to cause signal line 62 to generate electromagnetic fields of different magnitude for simulating different end-use applications. One example application for which device 52 may be calibrated includes a “smart shelf” RFID system, in which a shelf for storing files or other items is equipped with RFID interrogation capability to aid in tracking and locating the files within the RFID system.

In the example of FIG. 6, device 52 is configured with a signal line 62 that provides a propagating wave guide for interrogating files or other items having an RFID tag 58 located within a near field (i.e., fringing field or bound field) produced by the signal line. Signal line 62 is positioned in an orientation and distance with respect to file 56 that is expected to be used within the end-use application of a “smart shelf” storage area. Signal line 62 is oriented and driven to produce an electromagnetic field of the same field magnitude and direction as is expected to be produced by a shelf-based antenna in operation. Device 52 interacts with software executing on computer 66 to evaluate the performance of RFID tag 58 under the simulated conditions and provide a user with feedback on the performance characteristics of RFID tag 58. Examples of signal line structures are described in co-pending application Ser. No. 11/904,616, filed on Sep. 27, 2007, entitled SIGNAL LINE STRUCTURE FOR A RADIO-FREQUENCY IDENTIFICATION SYSTEM, Attorney Docket No. 63614US002, the entire contents of which is incorporated by reference herein.

In the example of FIG. 6, RFID system 50 also includes a computer 66 coupled to RFID reader 60 of device 52 via cable 67. Alternatively, RFID reader 60 may wirelessly connect to computer 66. Computer 66 executes software for calibrating and controlling device 52 and for assessing the performance of RFID tag 58 with respect to a particular end-use RFID system. A user may interact with device 52 using a user interface, such as keyboard 70, and using display 68, both connected to computer 66. The user may set calibration parameters for device 52 using computer 66. RFID system 50 may provide feedback to the user regarding operational characteristics of the RFID tag 58 as applied to file 56. For example, RFID system 50 may indicate a pass/fail condition to the user via display 68.

Device 52 includes a barcode scanner 64 for reading a barcode 65 affixed to file 56. In addition to performing verification functions, device 52 may be used for converting barcode-labeled items to RFID-tagged items. That is, device 52 may read information from barcode 65 affixed to file 56, and write corresponding information to RFID tag 58 that has been affixed to file 56. Device 52 may also interact with software running on computer 66 to associate a barcode identifier (ID) of barcode 65 with an ID of the RFID tag. For example, computer 66 may store the association between the barcode ID and the RFID tag ID within a database. Thus, device 52 may be a multipurpose device having both conversion and verification-checking functions. In some embodiments, device 52 may test the position and functionality of RFID tag 58 at the time of conversion (i.e., updating the database to associate the RFID tag with the bar code and/or programming of the RFID tag with information associated with the barcode of the tag). Device 52 may include an optional sensor 53 that, when activated, causes device 52 to begin the location and functionality testing process by transmitting read or write command signals to RFID tag 58 via signal line 62. The sensor 53 may be attached to item holder 54, and may be activated upon sensing the presence of file 56 within item holder 54.

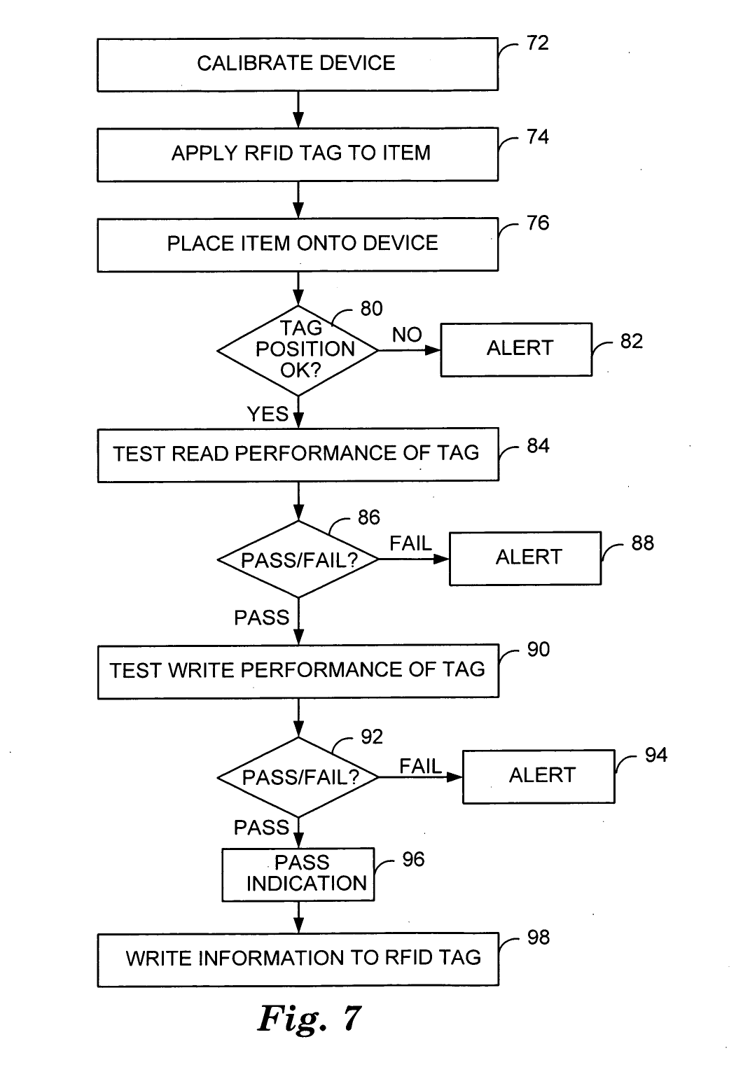

FIG. 7 is a flowchart illustrating example operation of the RFID system 50 of FIG. 6. A user may calibrate device 52 to simulate a particular end-use application (72). For example, the user may interact with computer 66 or reader 60 to manually specify one or more power level settings for RFID reader 60 such as a default power level and a minimum power level for creating an electromagnetic field having a strength substantially equal to or slightly lower than a field strength that is expected to be achieved by the electromagnetic field in the end-use application. In addition, the user may install a particular signal line 62 corresponding to the type of signal line expected to be deployed in the end-use application, e.g., RFID-enabled shelf. The user may interact with a user interface provided by computer 66 for some aspects of calibrating device 52.

At the time of conversion for a particular item, the user may then select and apply an RFID tag 58 to an item, such as a file 56 (74), and place the item onto device 52 (76). Device 52 verifies that RFID tag 58 is in a proper location on file 56, as described in detail above (80). For example, device 52 may verify that RFID tag 58 is positioned within a readable volume of file 56 where signal line 62 can successfully read information from and write information to RFID tag 58. During this process, device 52 may create an electromagnetic field using a default power level for reader 60.

If there is a successful read of information from or write of information to RFID tag 58, device 52 may assume that RFID tag 58 is properly located on the file 56. If RFID tag 58 is not in a proper location on file 56 (NO branch of 80), i.e., the read or write operation was unsuccessful, device 52 may provide an alert to the user, e.g., via display 68 (82). However, the alert may be optional, as device 52 may continue on to test the read or write performance first before issuing an alert.

Once the proper positioning of RFID tag 58 has been verified (YES branch of 80), device 52 may further verify that RFID tag 58 is functional for one or more particular applications, i.e., for use in an RFID system having particular characteristics. In the example of FIG. 7, device 52 does this by testing read performance of RFID tag 58 (84). For example, device 52 may perform a series of attempts to read RFID tag 58 using different power settings for reader 60. That is, software executing on computer 66 may control reader 60 to drive signal line 62 at the initial (default) power level to create an electromagnetic field having a near field of a targeted intensity. After creating the electromagnetic field, reader 60 attempts to perform one or more read operations on tag 58 at the current power level and records whether each attempt at the current power level is successful. Computer 66 repeats this process to test the read performance of tag 58 at incrementally lower power settings until a power level is reached that causes signal line 62 to produce an electromagnetic field having a field strength that is substantially equal to or slightly lower than the user-designated minimum field strength expected to be reliably produced from an RFID antenna in the end-use interrogation system.

The number of iterations N (i.e., the number of different power levels utilized by reader 60) to perform the read performance test may be user defined. For example, the user may specify that ten (N=10) different power levels be used during the read performance test. In this example, computer 66 controls reader 60 to sequentially produce electromagnetic fields at ten different power levels including the initial power level specified by the user, the minimum power level specified by the user, and eight power levels computed by computer 66 as a series of power levels equally spaced (in terms of power) between the initial power level and the minimum power level. As another example, the user may specify a single (N=1) iteration to indicate that a single read performance test is to be performed. In this case, computer 66 may control reader 60 so as to combine the read performance test (step 84 of FIG. 7) with the position verification test (step 80 of FIG. 7) so that a single electromagnetic field is created using the minimum power level defined by the user.

If RFID tag 58 as applied to file 56 fails the read performance test (e.g., one or more read attempts fail), device 52 may provide an alert to the user, e.g., via display 68 (88). The alert may take the form of a simple failure message. Alternatively, the alert may present a report indicating the number of successful and/or failed write attempts at each of the power levels.

If RFID tag 58 as applied to file 56 passes the read performance test, device 52 may proceed to test the write performance of RFID tag 58 as applied to file 56 (90). In a manner similar to that described above with respect to the read performance test, a series of attempts to write to RFID tag 58 using different power settings for reader 60 is performed. That is, software executing on computer 66 controls reader 60 to drive signal line 62 at the initial (default) power level to create an electromagnetic field having a near field of a targeted intensity. After creating the electromagnetic field, reader 60 attempts to perform one or more write operations on tag 58 at the current power level and records whether each attempt at the current power level is successful. Computer 66 repeats this process to test the read performance of tag 58 at incrementally lower power settings until a power level is reached that causes signal line 62 to produce an electromagnetic field having a field strength that is substantially equal to or slightly lower than the user-designated minimum field strength expected to be reliably produced from an RFID antenna in the end-use interrogation system.

As with the read performance test, the number of iterations N (i.e., the number of different power levels utilized by reader 60) to perform the write performance test may be user defined. In the case where a single iteration (N=1) is specified, computer 66 may control reader 60 so as to combine the write performance test (step 90 of FIG. 7) with the position verification test (step 80 of FIG. 7) so that a single electromagnetic field is created using the minimum power level defined by the user. Moreover, although described separately from the read performance test, computer 66 may control reader 60 to concurrently perform the read performance and the write performance test. That is, for each power level, computer 66 may control reader 60 to attempt one or more read attempts and one or more write attempts.

If RFID tag 58 as applied to file 56 fails the write performance test (e.g., one or more of the write attempts fail), device 52 may provide an alert to the user, e.g., via display 68 (94). The alert may take the form of a simple failure message. Alternatively, the alert may present a report indicating the number of successful and/or failed write attempts at each of the power levels.

Ultimately, device 52 may provide an indication to the user via display 68 that RFID tag 58 as applied to file 56 has passed the read and write performance tests (96). Although shown as providing a single pass indication, device 52 may provide separate indications after each of the read and write performance tests. Device 52 may provide the fail alerts and pass indications using any of a variety of methods, such as an audible alert, or a textual or graphic indication via display 68.

Device 52 may then continue with a conversion process by writing information to the RFID tag 58(98), such as information relating to file 56, and/or updating a database so as to associate RFID tag 58 and file 56. For example, optical bar code scanner 64 may scan a bar code 65 of file 56 to obtain information relating to the item stored on bar code 65, and RFID reader 60 of device 52 may write some or all of the obtained information to RFID tag 58 via signal line 62.

As described above, device 52 may perform the location testing concurrently with either the read or write performance test (or both), instead of sequentially as shown in FIG. 7. For example, when device 52 attempts to read RFID tag 58 by sending a read command signal and the read operation is successful, system 50 may conclude both that RFID tag 58 is properly positioned on file 56 and that RFID tag 58 is functional with respect to the read performance requirements. Conversely, if device 52 attempts to read the RFID tag 58 by sending a read command signal but the read operation is unsuccessful, device 52 may prompt the user to check the position of RFID tag 58 on file 56 and reposition if necessary. After the user indicates that the position has been checked, device 52 may then attempt a second read of RFID tag 58. If the second read is unsuccessful, RFID system 50 may determine that RFID tag 58 has failed the read performance functionality requirements.

One example of an end-use RFID application for which device is an RFID-enabled storage area for storing files or other items having RFID tags. The RFID-enabled storage area may include a substrate providing a shelf for items having RFID tags. A signal line structure is electrically coupled to an RFID reader and includes at least one signal line affixed to a first side of the substrate to generate a radio frequency (RF) electromagnetic field for interrogating one or more of the RFID tags. An electrical conductor provides an electrical ground plane on a second side of the substrate opposite the signal line and is electrically coupled to the signal line via an electrical load.

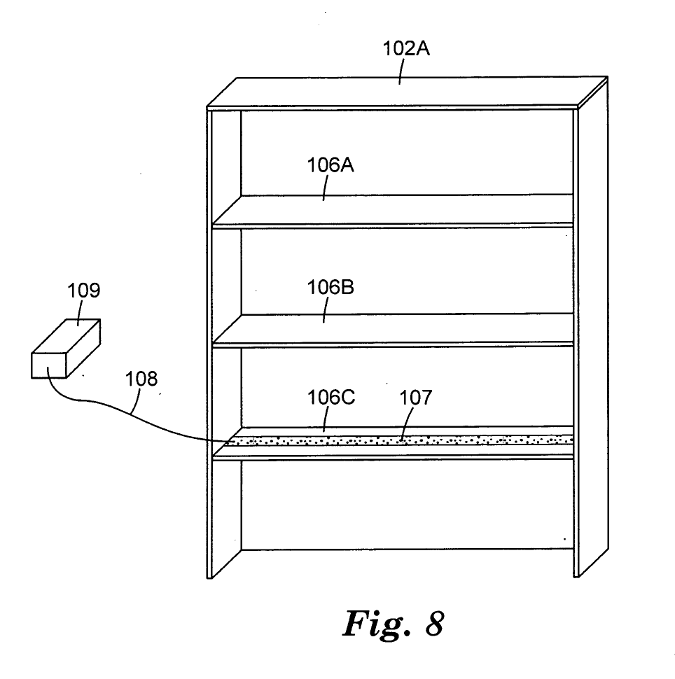

FIG. 8 is a block diagram illustrating an exemplary embodiment of smart storage area 102A that may be utilized within an end-use RFID application. As such, devices 10 and 52 may be utilized to verify proper placement and functionality of RFID tags with respect to smart storage area 102A at the time the RFID tag is applied to a file or other item but before the item is stored within smart storage area 102A.

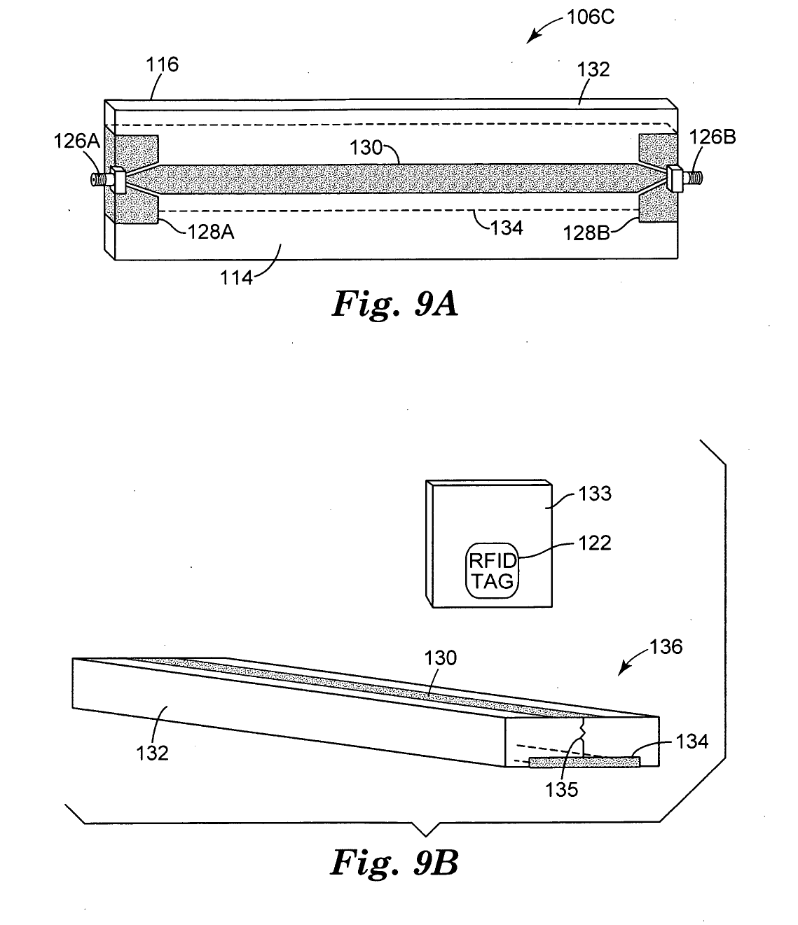

In this example embodiment, smart storage area 102A includes multiple shelves 106A-106C (collectively, “shelves 106”). Of course, in other embodiments, smart storage area 102A may contain more or fewer than three shelves. In the example of FIG. 9, smart storage area 102A contains shelf 106C having a signal line 107 of a signal line structure. Signal line 107 may be electrically coupled to an RFID reader 109 through a cable 108. Cable 108 may be any type of cable with the ability to transmit signals to and from RFID reader 109, for example a standard RG58 coax cable. One example of RFID reader 109 is Sirit Infinity 510 reader sold by Sirit, Inc. of Toronto, Canada. Books, folders, boxes, or other items containing RFID tags may be placed upon shelf 106C. RFID reader 109 powers signal line 107 through cable 108 by outputting a signal. When powered, signal line 107 generates an electromagnetic field, as described in further detail below. The electromagnetic field powers RFID tags located on the shelf 106C. The powered RFID tags may backscatter RF signals including information which is received by signal line 107 and electrically transmitted to RFID reader 109 through cable 108. For example, an RFID tag affixed to a folder positioned on shelf 106C may backscatter RF signals to RFID reader 109 acknowledging that the RFID tag (and correspondingly, the folder) is located on the shelf.

In other embodiments, each of shelves 106 may contain a signal line 107 of a signal line structure. In such embodiments, each shelf 106 may have a separate associated RFID reader 109. In another embodiment, multiple shelves 106 within smart storage area 102A may be cabled together to connect to a single reader 109. In such an embodiment, reader 109 may receive an acknowledgement indicating that a folder containing an RFID tag is located on a particular one of shelves 106 in smart storage area 102A.

In yet another embodiment, multiple smart storage areas 102 may be connected to each other. For example, cabling may be used to interconnect shelf 106C in smart storage area 102A with a shelf in smart storage area 102B, where the shelf in storage area 102B is substantially similar to shelf 106C. In such embodiments, a single reader 109 may interrogate items positioned within storage areas 102A and 102B to read information from the tags associated with the items and determine the location of a particular folder within smart storage area 102A or smart storage area 102B. Although described for purposes of example with respect to smart storage area 102A and 102B, any of smart storage areas 102 may include one or more signal lines 107 of a signal line structure that are used to interrogate items within the storage areas 102 as described herein. Additionally, embodiments using one or more RFID readers 109 connected to one or more shelves 106 have been described.

FIG. 9A is a schematic of a perspective view of an exemplary embodiment of shelf 106C of FIG. 8 in further detail. Shelf 106C comprises substrate 132, which may be made from a polystyrene sheet, or other type of substrate material. Signal line 130 may be affixed onto a top surface 14 of shelf 106C, and ground plane 134 (represented by dashed lines) may be affixed onto a bottom surface 116 of shelf 106C. Other techniques for placing signal line 130 and ground plane 134 may be used. Signal line 130 may be coupled to connectors 126A and 126B at each end. In the example of FIG. 9A, connectors 126A and 126B are illustrated as SubMiniature version A (SMA) connectors, but other types of connectors may also be used. Ground plane portions 128A and 128B are portions of ground plane 134 that have been wrapped around to extend to the top surface 114 of shelf 106C. As one example, signal line 130 and ground plane 134 may be composed of copper tape. In one example embodiment, the width of ground plane 134 may be at least twice the width of signal line 130. In another example embodiment, the width of ground plane 134 may be at least three times the width of signal line 130. In another example embodiment, the width of ground plane 134 may be at least four times the width of signal line 130. As illustrated below, the width of the ground plane 134 relative to the width of signal line 130 impacts the read range of the signal line structure of shelf 106C.

RFID reader 109 (FIG. 8) is coupled to connector 126A through cable 108. To avoid impedance mismatches between RFID reader 109 and connector 126A, a matching structure is used to efficiently couple power from RFID reader 109 to signal line 130 and reduce reflections at connector 126A. In embodiments where only one shelf 106C is being used, a load may be connected to connector 126B for proper termination. As one example, a 2 Watt, 50 Ohm load may be used.

FIG. 9B is a schematic of a perspective view of a shelf having an exemplary signal line structure 136. Signal line structure 136 includes at least one signal line 130, ground plane 134, and in some embodiments a load 135. Signal line 130 and ground plane 134 may be separated by substrate 132. In other embodiments, signal line structure 136 may include a plurality of signal lines substantially similar to signal line 130. A folder 133 containing an RFID tag 122 may be placed upon signal line 130. Embodiments described herein will refer to a signal line or signal lines, but one skilled in the art will realize that the signal line or signal lines are part of a signal line structure.

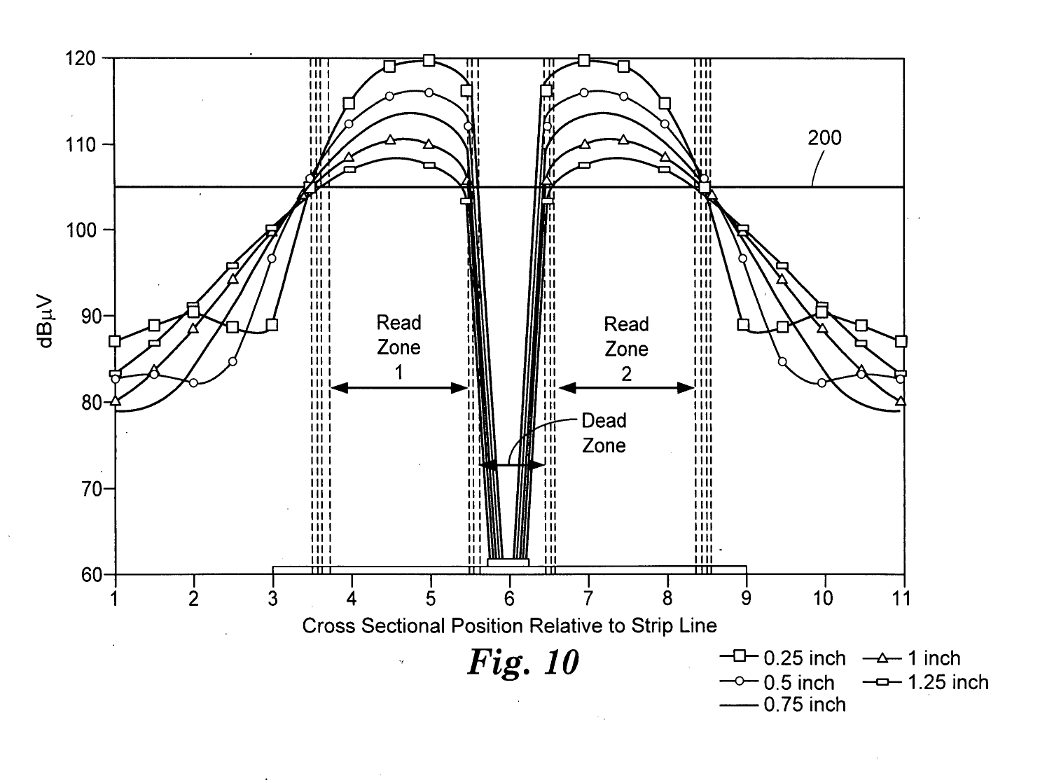

FIG. 10 is a graph illustrating magnitudes of electromagnetic fields modeled for an example signal line 62 at various cross-sectional positions relative to a strip line of an RFID shelf microstrip antenna, measured with the RFID tag at various distances from the RFID shelf antenna. FIG. 10 illustrates example data that may be used for determining minimum and maximum field magnitudes generated by device 52 within which a tag must respond for a particular end-use application. For example, the modeling data shown in FIG. 10 relates to the example application of a “smart shelf” RFID system described above with respect to FIGS. 8, 9A and 9B, in which a shelf for storing files or other items is equipped with RFID interrogation capability to aid in tracking and locating the files within the RFID system. Further details of an RFID-enabled smart shelf having signal line structures for interrogating files or other items are described in co-pending application Ser. No. 11/904,616, filed on Sep. 27, 2007, entitled SIGNAL LINE STRUCTURE FOR A RADIO-FREQUENCY IDENTIFICATION SYSTEM, Attorney Docket No. 63614US002, the entire contents of which is incorporated by reference herein.

The modeling results shown in FIG. 10 for the example end-use RFID application were computed assuming a smart shelf having a substrate 132 composed of 250 mils (6.35 mm) of polystyrene, a signal line 130 of 1 inch (25.4 mm) in width and 11 inches (279.4 mm) in length, and a ground plane 134 of 4 inches (101.6 mm) in width and 11 inches (279.4 mm) in length.

At a distance of 0.75 inches (19 mm) above signal line 130, for example, between cross-sectional positions of shelf 106C of 1 inch (25.4 mm) and 3.5 inches (88.9 mm), the electromagnetic power increases from about 80 dBμV to above 100 dBμV. Then between cross-sectional positions of shelf 106C of 3.5 inches (88.9 mm) and 5.8 inches (147.3 mm), the electromagnetic power increases to a maximum of about 113 dBμV at a cross-sectional position of about 4.8 inches (121.9 mm), and then starts to decrease until the electromagnetic power is close to 60 dBμV at a cross-sectional position of about 5.8 inches (147.3 mm). Between cross-sectional positions of shelf 106C of 5.8 inches (147.3 mm) and 6.2 inches (157.5 mm) the electromagnetic power remains less than 60 dBμV. Between cross-sectional position of 6.2 inches (157.5 mm) and about 6.5 inches (165.1 mm) the electromagnetic power increases to above 100 dBμV. Between cross-sectional position of 6.5 inches (165.1 mm) and about 8.5 inches (215.9 mm), the electromagnetic power increases to a maximum of about 113 dBμV at cross-sectional position of about 7.5 inches (190.5) and then decreases until the power is about 80 dBμV at cross-sectional position of 11 inches (279.4 mm).

At a distance of 1 inch (25.4 mm) above signal line 130, between cross-sectional positions of shelf 106C of 1 inch (25.4 mm) and 3.5 inches (88.9 mm), the electromagnetic power increases from about 80 dBμV to above 100 dBμV. Then between cross-sectional positions of shelf 106C of 3.5 inches (88.9 mm) and 5.8 inches (147.3 mm), the electromagnetic power increases to a maximum of about 110 dBμV at a cross-sectional position of about 4.8 inches (121.9 mm), and then starts to decrease until the electromagnetic power is close to 60 dBμV at a cross-sectional position of about 5.8 inches (147.3 mm). Between cross-sectional positions on shelf 106C of 5.8 inches (147.3 mm) and 6.2 inches (157.5 mm) the electromagnetic power remains less than 60 dBμV. Between cross-sectional positions on shelf 106C of 6.2 inches (157.5 mm) and about 6.5 inches (165.1 mm) the electromagnetic power increases to above 100 dBμV. Between cross-sectional positions on shelf 106C of 6.5 inches (165.1 mm) and about 8.5 inches (215.9 mm), the electromagnetic power increases to a maximum of about 110 dBμV at a cross-sectional position of about 7.5 inches (190.5 mm) and then decreases until the power is about 80 dBμV at a cross-sectional position of 11 inches (279.4 mm).

At a distance of 1.25 inches (31.7 mm) above signal line 130, between cross-sectional position of shelf 106C of 1 inch (25.4 mm) and 3.5 inches (88.9 mm), the electromagnetic power increases from about 80 dBμV to above 100 dBμV. Then between a cross-sectional positions of shelf 106C of 3.5 inches (88.9 mm) and 5.8 inches (147.3 mm), the electromagnetic power increases to a maximum of about 108 dBμV at a cross-sectional position of about 4.8 inches (121.9 mm), and then starts to decrease until the electromagnetic power is close to 60 dBμV at a cross-sectional position of about 5.8 inches (147.3 mm). Between a cross-sectional position of 5.8 inches (147.3 mm) and 6.2 inches (157.5 mm) the electromagnetic power remains less than 60 dBμV. Between a cross-sectional position of 6.2 inches (157.5 mm) and about 6.5 inches (165.1 mm) the electromagnetic power increases to above 100 dBμV. Between a cross-sectional position of 6.5 inches (165.1 mm) and about 8.5 inches (215.9 mm), the electromagnetic power increases to a maximum of about 108 dBμV at a cross-sectional position of about 7.5 inches (190.5 mm) and then decreases until the power is about 80 dBμV at 11 inches (279.4 mm).

FIG. 10 also depicts anticipated read zones that may exist when the RFID tag requires a minimum field strength of 105 dBμV for proper operation. Line 200 indicates a required signal strength that was determined to be required for reliable communication with an RFID tag located within the modeled smart storage area. FIG. 10 and the related modeled data may be used to parameterize an end-use RFID system's ability to read an RFID tag as a function of both the distance of the RFID tag from the signal line and the cross-sectional position with respect to the shelf. Computer 66 (FIG. 6) is configured with input parameters (power settings, interrogation durations) to control reader 60 to drive signal line 62 and produce an electromagnetic field so as to emulate the characteristics determined for the end-use application. Such characteristics may be determined by accurate modeling (as illustrated in the above example) or by measurement of accurate empirical data collected from the target end-use application.

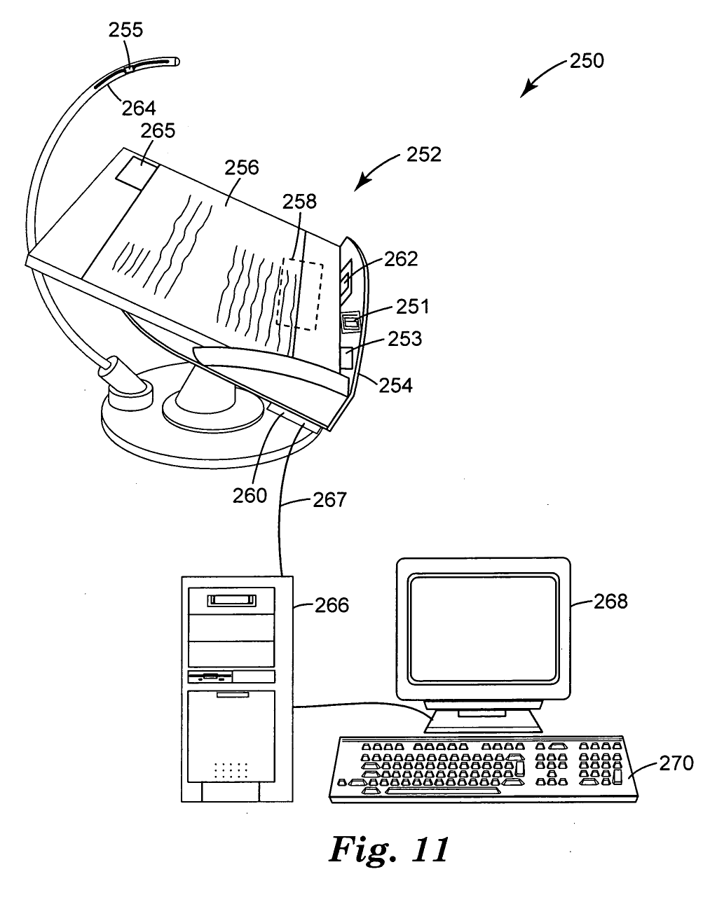

FIG. 11 is a perspective drawing illustrating another example RFID system 250. RFID system 250 includes a third exemplary device 252 for verifying the location and functionality of RFID tags on items with respect to an end-use RFID environment within which the items will ultimately be utilized. Device 252 provides a means for testing the performance of RFID tags that may be subject to a variety of applications where the various applications may rely on the performance of various reader-to-tag power coupling mechanisms. That is, device 252 provides means for verifying and characterizing RFID tag performance with respect to different forms of power coupling between the RFID reader and the RFID tag, namely when: electric near-field reader-to-tag power coupling, magnetic near-field reader-to-tag power coupling, and far-field reader-to-tag power coupling (where a balance of electric and magnetic fields) exist.

Device 252 expands upon the concepts described above to provide a device for testing RFID tag performance when an end-use RFID application uses at least two different reader-to-tag power coupling mechanisms to interrogate RFID tags. For example, a file tracking system may include an RFID-enabled smart shelf as described above and one or more RFID-enabled exit/entrance portals. As described above with respect to FIGS. 8, 9A and 9B, the RFID-enabled smart shelf may use a signal line that operates as a wave guide for near-field power coupling with the RFID tag (i.e., coupling by way of the electric field or “bound” field produced by the signal line). In contrast, the portal may use a far-field coupling mechanism for powering and communication with the RFID tag. Device 252 provides for testing of RFID tags for a minimum level of performance for each of the different reader-to-tag power coupling mechanisms expected to be utilized with the RFID tag once deployed to the end-use application. Moreover, device 252 may be controlled so as to test and verify that a tag has a user-defined level of performance that is specified for each of the reader-to-tag coupling mechanisms. For example, device 252 may be controlled so as to test and verify that the tags provides a high level of performance for one of the reader-to-tag power coupling mechanisms while achieving a lesser but acceptable degree of performance with respect to other read-to-tag power coupling mechanisms.

This can be useful in ensuring that RFID tags (e.g., UHF tags) are positioned correctly on items and will likely perform as expected when the items move through a variety of locations of the end-use environment that potentially uses a variety of different reader-to-tag coupling mechanisms. Advantageously, device 252 can be utilized to test and verify the performance of an RFID-tagged item to insure that the RFID tagged item will likely operate reliably in all of the scenarios expected for the end-use application.

Similar to device 52 described above, device 252 includes an item holder 254 that may hold an item, such as file 256. File 256 includes RFID tag 258 (shown by dotted lines) attached to the underside of file 256 or to an inner surface of file 256. In other embodiments, RFID tag 258 may be attached to a top surface of file 256.

In the example of FIG. 11, device 252 includes a means of producing an electric field such as a differentially driven pair of plates 262 to produce an electric field for near field (i.e., bounded field) power coupling with RFID tag 258. In addition, device 252 includes a loop antenna 251 for magnetic field power coupling with RFID tag 258 within the near field (bound/non-radiating field). Furthermore, device 252 includes a dipole antenna 255 for far field (radiated field) power coupling with the RFID tag. Each of plates 262, loop antenna 251 and dipole antenna 255 may be coupled to a different output port of RFID reader 260. In this way, device 252 includes three different power-coupling mechanisms that may be utilized for verifying and testing the performance of RFID tag 258 under different power-coupling schemes. In another embodiment, plates 262 may alternatively be replaced with a microstrip antenna, as described above with respect to FIG. 6.

As described herein, device 252 may be configured and operated in a manner to simulate conditions for a particular end-use application in which RFID tags will ultimately be employed, including applications that utilize multiple different coupling mechanisms for powering and interrogating the RFID tags. RFID reader 260 may also be calibrated or otherwise operated so as to simulate conditions of the particular application.

For example, device 252 may be designed such that a distance and orientation of RFID tag 258 with respect to plates 262 emulates acceptable worst-case conditions that are anticipated in the end-use RFID application once file 256 is deployed within the end-use application, e.g., stored on a shelf. In addition, an output power of device 252 for plates 262, an output power of device 252 for loop antenna 251, and an output power of device 252 for dipole antenna 255 may each be calibrated or otherwise controlled by reader 260 and computer 266 to produce an electromagnetic field having a field strength that is substantially equal to a minimum field strength that has been determined to be reliably produced from an RFID antenna in the end-use interrogation system. As a result, the functionality of RFID tag 258 with respect to the particular application, as well as the positioning of RFID tag 258 on file 256, may be tested as a basis for predicting how RFID tag 258 would perform in an environment that is the same or similar to the end-use RFID environment that will be encountered once file 256 is put to use. In this way, RFID tags 258 on files 256 may be tested for acceptable functionality relative to the performance requirements specified for a particular RFID application, i.e., of a particular type of RFID system and surrounding conditions.

Plates 262 are located within device 252 such that when file 256 is placed within the device and RFID tag 258 is properly positioned on the file, then the RFID tag is located within a near-field range of the plates. For example, the range of the near field of plates 262 extends to a distance of λ/2π, where λ represents the wavelength of the RF signal provided to the signal line by reader 260

$$( λ = \frac{c}{frequency} ) .$$

The positioning of plates 262 relative to RFID tag 258 within device 252 replicates positioning of a near field coupling mechanism (e.g., signal line 107) within the end-use application (e.g., smart shelf 106C).

Loop antenna 251 is also positioned within device 252 so that RFID tag 258 is located within a near field of the loop antenna for magnetic field power coupling when file 256 is placed within the device and the RFID tag is properly positioned within the file. Reader 260 selectively activates loop antenna 251 instead of plates 262 or dipole antenna 255 so as to test and verify performance of RFID tag 258 when magnetic field coupling via the near field is used to power RFID tag 258.

Mount 264 extends outwardly from device 252 so that tag 258 also falls within a far field (radiating field) of the electromagnetic field created by dipole antenna 255. The far field range of an antenna generally begins at a distance of 2D²/λ from the test antenna and extends beyond that distance, where λ represents the wavelength of the RF signal used for the test

$$( λ = \frac{c}{frequency} )$$

and D is the largest dimension of the test antenna (e.g., an end-to-end distance across a dipole antenna). As such, while near-field plates 262 can be close relative to λ, a far-field dipole antenna must be positioned at a greater distance, since dimension D is often on the order of λ/2 and to be beyond the near field. In practice, positioning the far field dipole test antenna 255 on mount 264 about 12 inches or more from RFID tag 258 under test can be used to determine the far-field performance of the RFID tag.

The coupling mechanisms of device 252 can be mounted in individual test fixtures, or, electronically and/or mechanically switched in/out of one test fixture. Additionally, a single antenna could be electronically reconfigured and physically translated if necessary to perform the function of multiple test antennas using different power coupling mechanisms.

As discussed above, device 252 may be configured to take into consideration conditions stemming from a particular end-use environment, such as electromagnetic interactions from packaging of a product, electrical interference from co-located equipment or machinery, or other environmental conditions that will likely exist at a particular end-use application. In this way, device 252 is designed to test the functionality of RFID tag 258 as applied to a particular item or product to be used within a particular application, as opposed to merely testing functionality of RFID tag 258 alone. Device 252 may be used to ensure that RFID tag 258 as applied to file 256 meets minimum read/write performance standards for different power coupling scenarios that may occur in a particular end-use application after RFID tag 258 is positioned on file 256.

In the example of FIG. 11, RFID system 250 also includes a computer 266 coupled to RFID reader 260 of device 252 via cable 267. Computer 266 executes software for calibrating and controlling device 252 and for assessing the performance of RFID tag 258 with respect to a particular end-use RFID system. A user may interact with device 252 using a user interface, such as keyboard 270, and using display 268, both connected to computer 266. The user may set calibration parameters for each power coupling mechanism of device 252 using computer 266. RFID system 250 may provide feedback to the user regarding operational characteristics of the RFID tag 258 as applied to file 256. For example, RFID system 250 may indicate a pass/fail condition and/or performance reports to the user via display 268 for each of the power coupling mechanisms, i.e., plates 262, loop antenna 251 and dipole antenna 255.

As with device 52, device 252 may include a barcode scanner for reading a barcode 265 affixed to file 256. In addition to performing verification functions, device 252 may be used for converting barcode-labeled items to RFID-tagged items. That is, device 252 may read information from barcode 265 affixed to file 256, and write corresponding information to RFID tag 258 that has been affixed to file 256. Device 252 may also interact with software running on computer 266 to associate a barcode identifier (ID) of barcode 265 with an ID of the RFID tag. For example, computer 266 may store the association between the barcode ID and the RFID tag ID within a database. Thus, device 252 may be a multipurpose device having both conversion and verification-checking functions. In some embodiments, device 252 may test the position and functionality of RFID tag 258 at the time of conversion (i.e., updating the database to associate the RFID tag with the bar code and/or programming of the RFID tag with information associated with the barcode of the file). Device 252 may include an optional sensor 253 that, when activated, causes device 252 to begin the location and functionality testing process by transmitting read or write command signals to RFID tag 258. The sensor 253 may be attached to item holder 254, and may be activated upon sensing the presence of file 256 within item holder 254.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A device for verifying a location and functionality of a radio-frequency identification (RFID) tag on an item, comprising:
an item holder;
a signal line affixed to the item holder; and
an RFID reader electrically connected to the signal line,
wherein the signal line creates a near field for transmission of read or write command signals from the RFID reader to an RFID tag applied to an item placed on the item holder, and
wherein the RFID reader verifies the location and the functionality of the RFID tag with respect to a near-field coupling mechanism of a particular end-use RFID system.

2. The device of claim 1, wherein an output power of the RFID reader is controlled to produce the read or write command signals from the signal line at a minimum field strength that has been determined to be reliably produced by the RFID reader in the end-use RFID system, and wherein the device determines whether the read or write command signals are received by the RFID tag.

3. The device of claim 2, wherein the device alerts a user when the RFID tag fails to respond to the read or write command signals having the minimum field strength.

4. The device of claim 1, wherein the signal line is of a type for use with the end-use RFID system.

5. The device of claim 1, wherein the device comprises a conversion station for converting non-RFID-tagged items to RFID-tagged items.

6. The device of claim 5, wherein the conversion station includes a barcode scanner for reading a barcode on the item, and wherein the RFID reader writes information obtained from the barcode by the barcode scanner to the RFID tag.

7. The device of claim 1, wherein the device comprises a readable volume and a non-readable volume such that when an RFID tag is within the readable volume, the RFID tag is properly located on an item, and when an RFID tag is within the non-readable volume of the holder, the RFID tag is not properly located on an item; wherein the device signals to a user when the RFID tag is properly located on an item.

8. The device of claim 1, further comprising a sensor attached to the item holder, wherein when the sensor is activated, the signal line transmits read or write command signals.

9. The device of claim 1, wherein the item holder is designed to hold a file having an RFID tag attached to the file.

10. The device of claim 1, further comprising:
a mount extending outwardly from the item holder; and
a dipole antenna affixed to the mount;
wherein the dipole antenna creates a far field for transmission of read or write command signals from the RFID reader to an RFID tag on an item placed on the item holder, and
wherein the RFID reader verifies the location and functionality of the RFID tag with respect to a far-field coupling mechanism of a particular end-use RFID system for the RFID tagged item.

11. The device of claim 1, further comprising:
a loop antenna affixed to the item holder at a position to create a near field for transmission of read or write command signals from the RFID reader to an RFID tag on an item placed on the item holder, and
wherein the RFID reader verifies the location and functionality of the RFID tag with respect to a magnetic near-field coupling mechanism of a particular end-use RFID application.

12. A method of verifying a location and functionality of a radio-frequency identification (RFID) tag on an item, comprising:
providing a device for verifying a location and functionality of an RFID tag on an item, the device comprising an item holder, a signal line attached to the item holder, and an RFID reader electrically connected to the signal line, wherein the signal line creates a near field for transmission of read or write command signals from the RFID reader to an RFID tag applied to an item placed on the item holder, and wherein the RFID reader verifies the location and functionality of the RFID tag with respect to a near-field coupling mechanism of a particular end-use RFID system;
calibrating the device such that the device produces a near field that simulates a near field expected to produced by the near-field coupling mechanism of the end-use RFID system;
attaching an RFID tag to an item;
inserting the item into the item holder of the device;
transmitting RF signals from the RFID reader to the RFID tag with the signal line at a power level for simulating the end-use RFID system; and
verifying the functionality of the RFID tag with respect to the end-use RFID system upon determining that the RF signals were successfully received by the RFID tag.

13. The method of claim 12, further comprising providing an alert to a user when the RFID tag fails to communicate with the RFID reader.

14. The method of claim 12, wherein verifying further comprises verifying that the RFID tag is in a proper location on the item when the signals were successfully received by the RFID tag.

15. The method of claim 12, wherein calibrating the device comprises calibrating power level of reader to produce the near field at a strength at the location of the RFID tag that is substantially equal to a minimum field strength that has been determined to be reliably produced from an RFID antenna in the end-use interrogation system.

16. The method of claim 12, wherein the verifying step further comprises verifying the proper location when the RFID tag on the item is within a readable volume of the item holder, and signaling that the RFID tag is not in a proper location on the item when the RFID tag on the item is not with a readable volume of the item holder.

17. The method of claim 12, further comprising detecting presence of the item in the item holder with a sensor attached to the item holder, wherein when the sensor is activated, the signal line transmits read or write command signals.

18. The method of claim 12, wherein attaching the RFID tag to an item comprises attaching the RFID tag to a file.

19. A system for verifying a location and functionality of a radio-frequency identification (RFID) tag on an item, comprising:
an item having an RFID tag attached to the item;
a device comprising:
an item holder to hold the item;
a signal line attached to the item holder, and
an RFID reader electrically connected to the signal line, wherein the signal line creates a near field for power coupling with the RFID tag on the item when the item is placed on the item holder, and wherein the RFID reader verifies the location and functionality of the RFID tag with respect to a near-field coupling mechanism of a targeted end-use RFID system; and
a computer in operative connection to the RFID reader, wherein the device interacts with software running on the computer to characterize the performance of RFID tag with respect to the near-field coupling mechanism of the end-use RFID system and provide a user with feedback on the performance characteristics of the RFID tag.

20. The system of claim 19, further comprising:
a display; and
software executing on the computer to present a user interface by which a user calibrates the device to simulate the end-use RFID system.

21. The system of claim 19, wherein the device comprises a conversion station for converting non-RFID-tagged items to RFID-tagged items.

22. A device for verifying a location and functionality of a radio-frequency identification (RFID) tag on an item, comprising:
an item holder;
an RFID reader; and
at least two power coupling mechanisms connected to the RFID reader for power coupling with an RFID tag affixed to an item placed within the item holder, wherein the at least two power coupling mechanisms include at least: (i) a first power coupling mechanism that produces an electric field for near-field power coupling with the RFID tag, and (ii) a second power coupling mechanism that produces an electromagnetic field for far-field coupling with the RFID tag.

23. The device of claim 22,
wherein the first power coupling mechanism is a signal line affixed to the item holder that creates a near field for transmission of read or write command signals from the RFID reader to the RFID tag, wherein the RFID reader verifies the location and functionality of the RFID tag with respect to a near-field coupling mechanism of a particular end-use RFID system; and
wherein the second power coupling mechanism is a dipole antenna for transmission of read or write command signals from the RFID reader to the RFID tag, wherein the RFID reader verifies the location and functionality of the RFID tag as applied to the item with respect to a far-field coupling mechanism of a particular end-use RFID system.

24. The device of claim 22,
wherein the first power coupling mechanism is a loop antenna for transmission of read or write command signals from the RFID reader to an RFID tag on an item placed on the item holder, wherein the RFID reader verifies the location and functionality of the RFID tag as applied to the item with respect to a magnetic near-field coupling mechanism of a particular end-use RFID application, and
wherein the second power coupling mechanism is a dipole antenna for transmission of read or write command signals from the RFID reader to the RFID tag, wherein the RFID reader verifies the location and functionality of the RFID tag as applied to the item with respect to a far-field coupling mechanism of a particular end-use RFID system.

25. The device of claim 22,
wherein the first power coupling mechanism is a pair of plates for transmission of read or write command signals from the RFID reader to an RFID tag on an item placed on the item holder, wherein the RFID reader verifies the location and functionality of the RFID tag as applied to the item with respect to a near-field coupling mechanism of a particular end-use RFID application, and
wherein the second power coupling mechanism is a dipole antenna for transmission of read or write command signals from the RFID reader to the RFID tag, wherein the RFID reader verifies the location and functionality of the RFID tag as applied to the item with respect to a far-field coupling mechanism of a particular end-use RFID system.
